(19) United States
(12) Patent Application Publication
(10) Pub. No.: US 2014/0040805 A1
(43) Pub. Date: Feb. 6, 2014

(54) CHART GENERATION BASED ON USER CONTROL INFERENCES

(71) Applicants: JoAnn P. Brereton, Hawthorne, NY (US); Curtis H. Brobst, Elgin, MN (US); Tricia Y. Garrett, Raleigh, NC (US); Carolyn Hyink, Austin, TX (US); Alan Mikulan, Skerries (IE)

(72) Inventors: JoAnn P. Brereton, Hawthorne, NY (US); Curtis H. Brobst, Elgin, MN (US); Tricia Y. Garrett, Raleigh, NC (US); Carolyn Hyink, Austin, TX (US); Alan Mikulan, Skerries (IE)

(73) Assignee: International Business Machines Corporation, Armonk, NY (US)

(21) Appl. No.: 13/565,563

(22) Filed: Aug. 2, 2012

(51) Int. Cl. G06F 3/048

(52) U.S. Cl. 715/771

(57) ABSTRACT

In some example embodiments, a computer-implemented method includes receiving, for each of a number of user interface controls, selections by a user of at least one of exactly one value, a subset of values, all values, and no values. The selections by the user define non-chart-related settings, The method includes inferring intent of the user of at least one attribute of a chart based on the selections by the user via the number of user interface controls. The method includes defining at least one characteristic of the chart for displaying the chart based on the intent.

### BACKGROUND

Embodiments of the inventive subject matter generally relate to the field of computers, and, more particularly, to generation of charts based on user control inferences.

Accessing different types of data to view and analyze in a meaningful way can be time consuming and onerous. Typically, a user is required to enter input multiple times regarding data to be presented to them by maps, lists, reports, charts, etc. Conventional systems retrieve the requested data for viewing and analysis based on the input from the user.

### SUMMARY

In some example embodiments, a computer-implemented method includes receiving, for each of a number of user interface controls, selections by a user of at least one of exactly one value, a subset of values, all values, and no values. The selections by the user define non-chart-related settings. The method includes inferring intent of the user of at least one attribute of a chart based on the selections by the user via the number of user interface controls. The method includes defining at least one characteristic of the chart for displaying the chart based on the intent.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a Graphical User Interface (GUI) having user interface controls for receiving inputs about data queries, according to some example embodiments.

FIG. 2 depicts a GUI that is an output result based on data queries that includes graphical output of the data queries and a chart derived from user inferences based on user interface controls relative to the data queries, according to some example embodiments.

FIG. 3 depicts a flowchart of operations for generating a chart, derived from user inferences based on user interface controls relative to the data queries, according to some example embodiments.

FIG. 4 depicts a computer system, according to some example embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

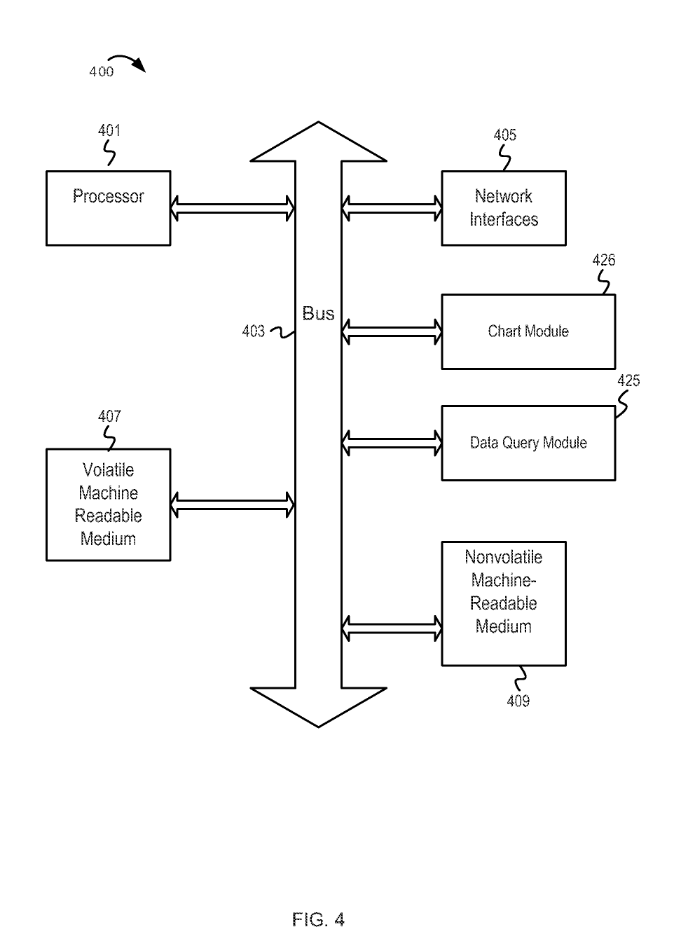

Some example embodiments enable a user to delegate decisions about the different characteristics for charts provided to them based on inferences that are derived from user input regarding settings or parameters providing for data queries that are not for charts (i.e., non-chart based settings). Some example embodiments can be performed by a data query module and a chart module. The data query module and the chart module can be software, firmware, hardware or a combination thereof to perform the operations described below. For example, the data query module and the chart module can be software executing on a processor. An example of such a configuration is depicted in FIG. 4 (which is described in more detail below).

In some example embodiments, a chart is defined to include any type of report, table, graph, diagram, etc. that is derived from user inputs for data queries. The user can specify one or more settings for a data query, wherein the results provide an indication of the user's interest. In response, the data query module can retrieve and display this results set. Additionally, based on the state of these non-chart, based settings (the data query inputs by the user), the chart module makes inferences to determine the charts that would provide additional insight to the user. Along with the results set, the chart module can return a chart befitting the results set. Some example embodiments alleviate the need for a user to specify their interests multiple times for different types of charts and information about requested data. For example, a user is not required to both complete a user interface dialog to return results for a map and list about a set of data and make additional or separate decisions about charts related to the data. In some example embodiments, the user can be given the option to have charts generated by the chart module or to manually define the characteristics of the chart.

Some example embodiments enable a user to delegate charting decisions to the chart module. The chart module can infer a reasonable set of chart characteristics from the user's other user interface input that is not specific to chart-based settings. The chart characteristics delegated to the chart module can include a type of graph (bar, stacked bar, pie chart, etc.), a title for the chart, the second variable represented in each bar for a stacked bar graph, what is being compared (e.g., variables represented by each bar in a bar graph), etc.

Accordingly, as described, a user can receive a large amount of information about the data they are requesting with relatively little interaction. Also, the user is not bogged down by making a number of chart decisions. In particular, some example embodiments allows the user to focus on the “what” of their data and not the “how” relative to presenting the data. Additionally, some example embodiments prevent errors in the creation of the charts. In particular, some example embodiments help a user avoid selecting charting options that are incompatible or merely inadvisable given their data of interest.

During operation, the user specifies one or more settings that provides to the data query module a results set of data that the user is requesting from the system. In response, the data query module can retrieve and display this results set to the user. These settings specified by the user are non-charting-related settings. Based on these settings, the chart module can make inferences to determine the chart(s) that would provide insight to the user regarding the results set. Accordingly, along with the results set, the chart module can return chart(s) befitting the results set.

To further illustrate, conventional operations as compared to operations according to some example embodiments are now described. Conventional operations for receiving a chart by a user are first described. In a first operation, a user enters a data query that specifies what data the user wants. For example, the user can request data for work orders for any of 20 asset types, four work types, any problem or priority. In a second operation, the user defines the data set for the chart. In particular, the user specifies the results set that matches the data query. For example, the user can select cells in a spreadsheet. In a third operation, the user defines the type of chart. In particular, the user specifies the focus of the query about this data set. For example, the user can specify a type of chart that provides work orders by asset type, work orders by priority, etc. In a fourth operation, the user defines the layout and specifics of the chart. In particular, the user defines how to present the graphical part of the chart. Examples of such details include type of chart (e.g., bar, pie, etc), x-axis units and labels, y-axis units and labels, etc. In a fifth operation, the user defines what to do with the chart after the chart is generated. In particular, the user defines whether to modify, reuse, repurpose, aggregate with other charts, etc. For example, the user can request that a new chart type be shown, aggregate charts related to this data set, etc. In contrast to these conventional operations, for operations according to some example embodiments, the user is only required to perform the first and the fifth operations. The user is not required to perform the second, third, and fourth operations.

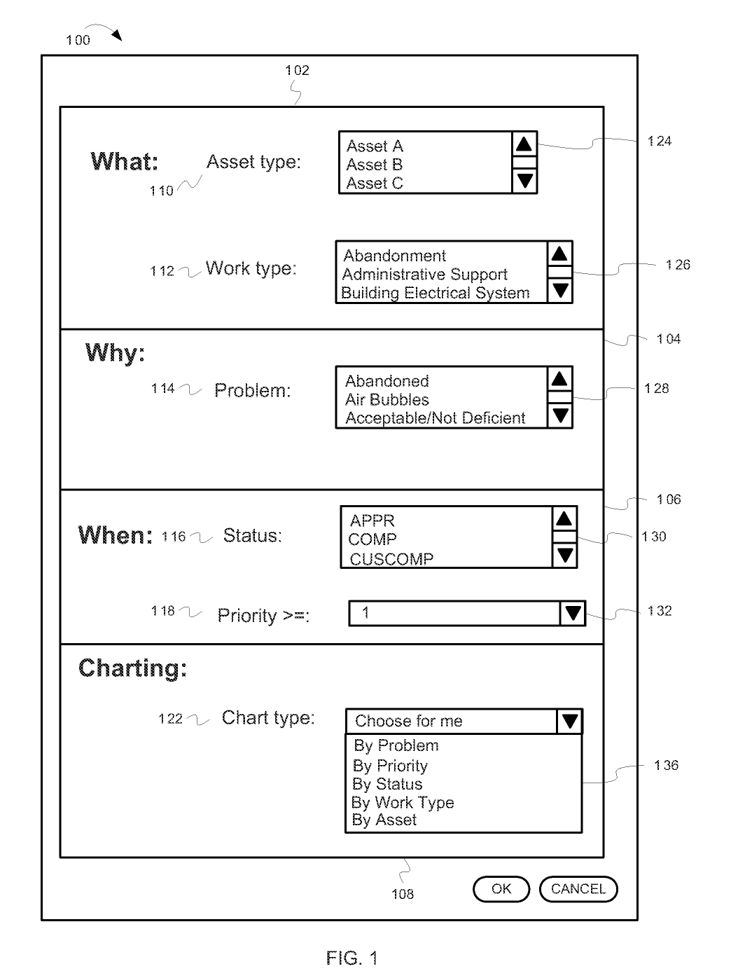

FIG. 1 depicts a Graphical User Interface (GUI) having user interface controls for receiving inputs about data queries, according to some example embodiments. In particular, FIG. 1 depicts a GUI 100 for work orders. The GUI includes four sections having different user interface controls for providing user input for a data query—a section 102, a section 104, a section 106, and a section 108. The section 102 provides the user interface controls for the “what” of the data query for the work order. The section 104 provides user interface controls for the “why” of the data query for the work order. The section 106 provides user interface controls for the “when” of the data query for the work order. The section 108 provides user interface controls for the “charting” of the data query for the work order.

In the section 102, a user interface control 124 allows the user to identify one or more asset types 110 that the user wants to view as part of a data query. Also in the section 102, a user interface control 126 allows the user to identify one or more work types 112 that the user wants to view as part of a data query. In the section 104, a user interface control 128 allows the user to identify one or more problems 114 that the user wants to view as part of a data query. In the section 106, a user interface control 130 allows the user to identify one or more statuses 116 that the user wants to view as part of a data query. Also in the section 106, a user interface control 132 allows the user to identify one or more work priorities that the user wants to view as part of a data query. In the section 108, a user interface control 136 allows the user to select a chart type 122. In particular, the user can define their own chart or allow the chart module to create a chart derived from inferences that are based on the inputs from the other user interface controls in the GUI 100.

Each of the sections 102-106 include user interface controls wherein the user can select one, all, none or some (but less than all) of the options to create a data query. Assuming that the user enables the chart module to create a chart, the chart module can create a chart derived from inferences based on the different selections across the different user interface controls. For example, assuming the user has selected exactly one value from a user interface control (e.g., Asset A from the user interface control 124 for the asset types 110), the chart module can infer that the user wants to create a chart that is filtered by this characteristic (asset types). In another example, assuming the user has selected a subset of values from a user interface control (e.g., Abandonment and Administrative Support from the user interface control 126 for the work types 112), the chart module can infer that the user wants to sort or compare by this characteristic (work types). In another example, assuming that the user has selected all or none of the values from a user interface control (e.g., no selection of problems from the user interface control 128 for the problems 114), the chart module can infer that the user does not consider this characteristic (problems) a differentiating factor in creating the chart.

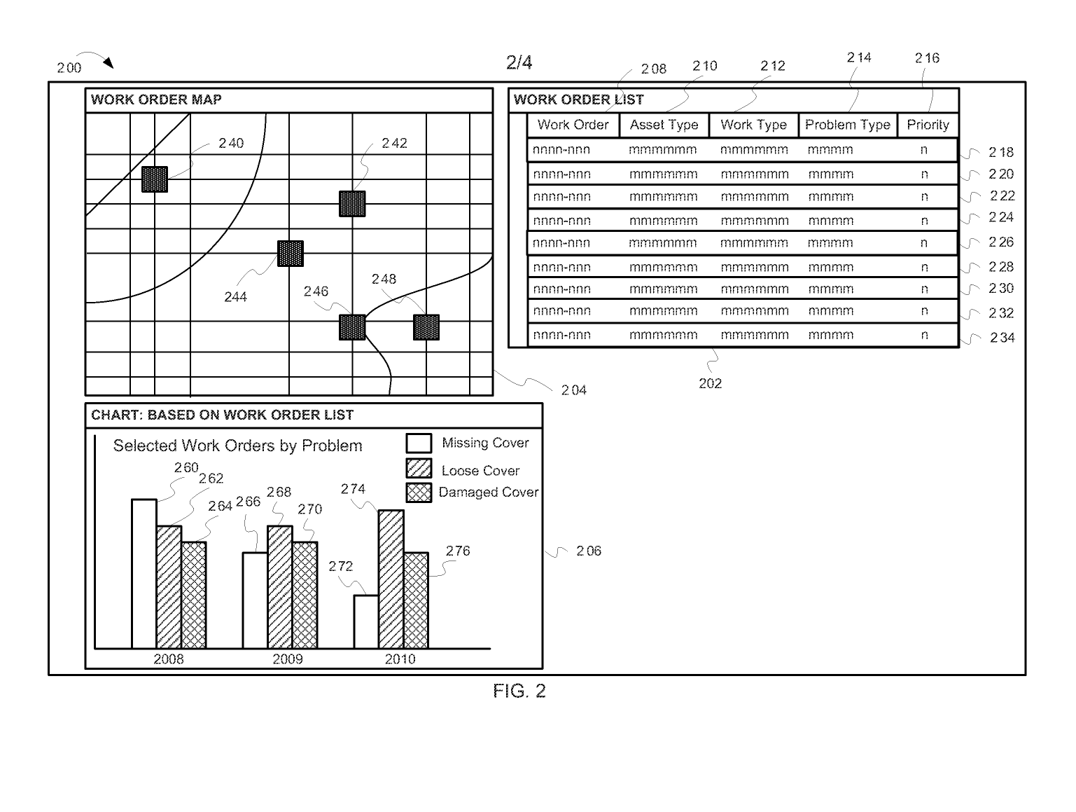

FIG. 2 depicts a GUI that is an output result based on data queries that includes graphical output of the data queries and a chart derived from user inferences based on user interface controls relative to the data queries, according to some example embodiments. In particular, FIG. 2 depicts a GUI 200 that includes two output results that are provided in response to a data query about work order. A first output result includes a work order list 202 that is a table of a number of entries—entries 218-234. Each entry includes a value for a work order, an asset type, a work type, a problem type and a priority. For example, the data query can include a request for a subset of work orders for a particular asset type. In response to the data query, the data query module can output a table that includes entries that satisfy these defined criteria. A second output result includes a work order map 204 that includes a map that identifies the geographic location for the work orders defined in the work order list. In the part of the map shown, the geographic locations for five different work orders are shown—geographic locations 240-248. The geographic locations for the other work orders in the work order list 202 are not shown in the GUI 200 but are viewable as different parts of the map become viewable.

In addition to providing the requested data as a result of the data query (via the work order list and the work order map), the GUI 200 displays a chart 206. The chart module can derive the chart 206 from inferences of the user based on the user input controls for the data query (see examples described in reference to FIG. 1 above). In this example, the chart 206 is the two-dimensional bar chart for selected work orders by problem. In this example, the selected problems are for a specific asset type (manhole covers) and include, a missing cover, a loose cover, and a damaged cover. The chart, module can define the type of chart, the title of the chart and the characteristics to be viewed based on the user input to the user interface controls. In this example, the user has selected exactly one asset type—manhole cover. Accordingly, the chart module would infer that the user wants to filter based on this asset type. Additionally, the user has selected a subset of values for the problems (a missing cover, a loose cover, and a damaged cover). Accordingly, the chart module would infer that the user wants to sort or compare based on this subset of values. Additionally, the user may have selected all or none for any of status, priority, and work type. Accordingly, the chart module can infer that the user does not consider these characteristics differentiating factors in creating the chart.

Therefore, as shown, the chart module creates a two-dimensional bar chart with the y-axis providing a quantity of work orders for the three different problems and with the x-axis providing years for the three different problems. Also, note the chart module has created a title for the chart 206—“Selected Work Orders by Problem.” If the user has selected all problems for a particular asset type, the chart module can create a different title for the chart 206—“All Work Orders.” As shown, the chart 206 includes a bar 260 representing the missing covers for 2008; a bar 262 representing the loose covers for 2008; and a bar 262 representing the damaged covers for 2008. The chart 206 also includes a bar 266 representing the missing covers for 2009; a bar 268 representing the loose covers for 2009; and a bar 270 representing the damaged covers for 2009. The chart 206 also includes a bar 272 representing the missing covers for 2010; a bar 274 representing the loose covers for 2010; and a bar 276 representing the damaged covers for 2010.

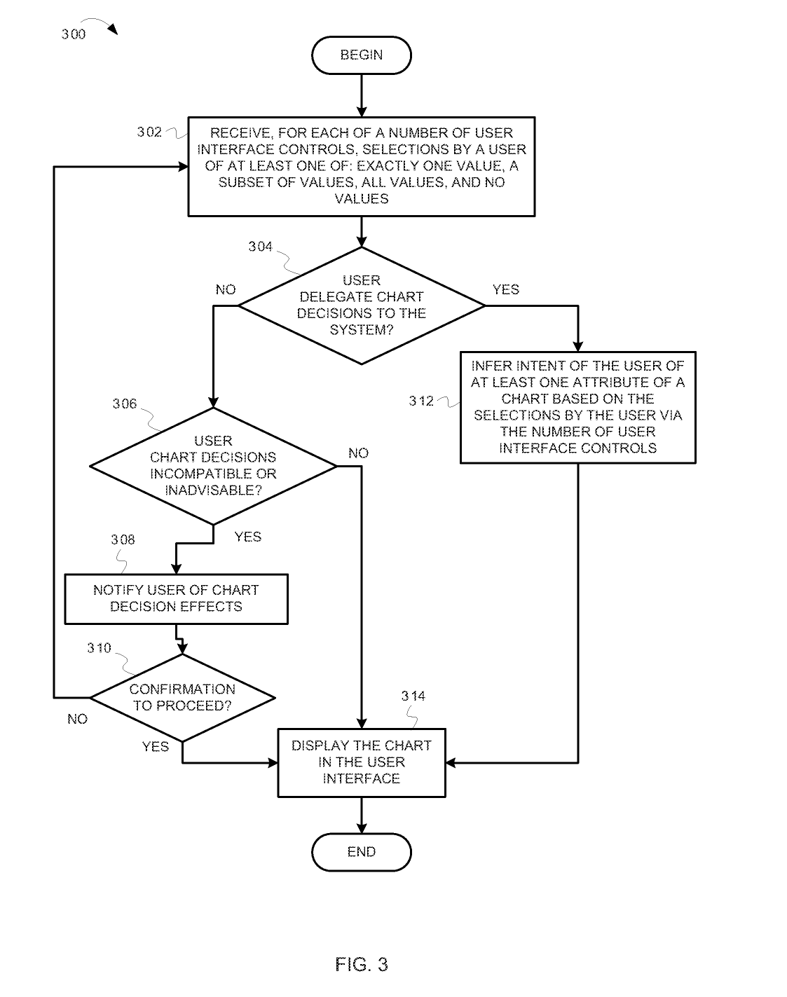

FIG. 3 depicts a flowchart of operations for generating a chart derived from user inferences based on user interface controls relative to the data queries, according to some example embodiments. FIG. 3 depicts a flowchart 300. Operations of the flowchart 300 are described in reference to FIGS. 1-2. In this description, the operations are described as being performed by a data query module 425 and a chart module 426 of FIG. 4, which is described in more detail below. In particular, the data query module 425 and the chart module 426 can be software executing on at least one processor for performing the operations described. The operations of the flowchart 300 begin at block 302.

At block 302, the data query module receives, for each of a number of user interface controls, selections by a user of at least one of: exactly one value, a subset of values, all values, and no values. For example with reference to FIG. 1, the data query-module receives selections for each of the number of user interface controls (124-132). For each of the number of user interface controls, the user can select exactly one value, a subset of values, all values, and no values. Operations of the flowchart 300 continue at block 304.

At block 304, the data query module determines whether the user has delegated decisions for creating a chart to the system. For example with reference to FIG. 1, the user interface control 136 allows the user to select a chart type, One of the options is “choose for me”. If the user makes this selection, the data query module determines that the user wants the system to create the chart. Otherwise if the user selects any of the other options for the chart type, the data query module determines that the user wants to make their own chart decisions. If the user has not delegated decisions for creating a chart to the system, operations of the flowchart continue at block 306. Otherwise, operations of the flowchart 300 continue at block 312.

At block 306, the data query module determines whether the user's chart decisions are incompatible or inadvisable. For example, the user may select a chart type, wherein the number of variables to be viewed are too many in comparison to the chart selected. To illustrate with reference to FIG. 1, the user may select a non-stacked bar chart while selecting a subset set of values for the work type, problem, and priority. Accordingly, the non-stacked bar chart cannot adequately display all of the different variables. In such an example, the user chart decisions are incompatible with the selection of values for the other user interface controls. If the user chart decisions are incompatible or inadvisable, operations of the flowchart 300 continue at block 308. Otherwise, operations of the flowchart continue at block 314.

At block 308, the data query module notifies the user of the chart decision effects. For example, the data query module can display on window over the GUI 100 that notifies the user that their chart decisions would be incompatible or inadvisable with the selection of values for the other user interface controls. Operations of the flowchart 300 continue at block 310.

At block 310, the data query module determines whether there is confirmation to proceed. For example, the window displayed over the GUI 100 can include a button to proceed and a button to cancel, thereby allowing the user to confirm proceeding with the selection of values for the different user interface controls. If there is not a confirmation to proceed, operations of the flowchart return to block 302. For example, the user can adjust the different selections of the user interface controls in the GUI 100. This can include allowing the system to perform the chart decisions and/or adjusting selections of values for one or more of the user interface controls 124-132. If there is a confirmation to proceed, operations of the flowchart 300 continue at block 314.

At block 312, the chart module infers intent of the user of at least one attribute of a chart based on the selections by the user via the number of user interface controls. In particular, the chart module can infer intent of the user based on the data query inputs by the user (the state of non-chart based settings). The chart module makes inferences to determine the charts that would provide additional insight to the user. With reference to FIGS. 1-2, the chart module makes inferences based on the selection of the values for the different user interface controls 124-132 to create the chart 206 in the GUI 200 depicted in FIG. 2. For example, assuming the user has selected exactly one value from a user interface control (e.g., Asset A from the user interface control 124 for the asset types 110), the chart module can infer that the user wants to create a chart that is filtered by this characteristic (asset types). In another example, assuming the user has selected a subset of values from a user interface control (e.g., Abandonment and Administrative Support from the user interface control 126 for the work types 112), the chart module can infer that the user wants to sort or compare by this characteristic (work types). In another example, assuming that the user has selected all or none of the values from a user interface control (e.g., no selection of problems from the user interface control 128 for the problems 114), the chart module can infer that the user does not consider this characteristic (problems) a differentiating factor in creating the chart.

To further illustrate inferring user intent, an example for creating a bar chart is now described. The chart module makes a number of assumptions. The chart module distills each of the selections by the user of the user interface controls into a number of states—1) exactly one value selected; 2) a subset of values selected, and 3) all or no values selected. Each of these states can imply a certain intent on behalf of the user. In some example embodiments, the chart module does not chart more than two variables on the y-axis and uses start and end times on the x-axis. In some situations, the chart module cannot reflect all of the user selections for a particularly intricate user data query.

In some example embodiments, the chart module sets precedence rules for the chart decisions. For example, the chart module can set precedence rules for displaying certain variables in the chart when multiple variables include a subset of values. To illustrate with reference to FIG. 1, assume a user has selected 10 choices for the problem 114 using the user interface control 128 and selected three choices for the work type 112 using the user interface control 126. In this situation, the chart module uses the work type 112 for display in the chart and does not include the problem 114 in the chart, because a bar chart for three variables is more readable in comparison to a bar chart with 10 variables. In such situations, even if the chart must neglect a subset of variables, the user can still view the full result set in the data query results shown (e.g., a list view, a map view, etc.). Accordingly, the chart module can define subset thresholds for these precedence rules. For example, assume that the number of values in a first subset of values exceeds a first subset threshold (e.g., 10, 6, etc.) and assume that the number of values in a second subset of values is below a second subset threshold (e.g., 4, 3, etc.). In this situation, the chart module uses precedence rules to infer the intent of the user to view the chart using the second subset of values. In another example, assume that the number of values in a first subset of values exceeds a first subset threshold (e.g., 10, 6, etc.) and assume that the number of values in a second subset of values exceeds a second subset threshold (e.g., 4, 3, etc.). In this situation, the chart module uses precedence rules to infer the intent of the user to view the chart using a third subset of values.

Returning to the example for creating a bar chart, operations are further described. The chart module first applies any filter dialog that reduces the universe of the data (e.g., assume data related to work orders). If the user's selections did not reduce the universe of work orders, the title of the chart begins with “All Work Orders.” If the user's selections did reduce the universe of work orders, the title of the chart begins with “Selected Work Orders.” Next, the chart module determines the number of user interface controls that are in the state—“subset of values selected.” The chart module then sets asides those user interface controls for these group of user interface controls, where the user has selected greater than a threshold (e.g., six). The chart module then counts the remaining user interface controls having this state (“subset of values selected”). If there are zero, the chart module uses a bar chart and appends “by Asset Type” to the title. If there is only one, the chart module uses a bar chart and appends “by X”, wherein X is the characteristic (e.g., “Problem”) for the only one user interface control. If there are between two and five, the chart module uses a stacked bar chart and applies a following set of precedence rules for the stacked bar chart.

A first precedence rule defines the primary variable in the stacked bar chart. The primary variable will be represented by N groups of one to five bars each. A second precedence rule defines the secondary variable in the stacked bar chart. The secondary variable will segment each bar into five or fewer parts of the whole. Next, the chart module determines the time units for the x-axis and the bars (analysis frequency). The chart module then finalizes setting the variables needed to be viewed (see precedence rules described above for the characteristics to be included in the bar chart). Returning to the flowchart 300 of FIG. 3 after inferring intent of the user to create the chart, operations of the flowchart 300 continue at block 314.

At block 314, the chart module displays the chart in the user interface. In particular, the chart module displays the chart that was based on user selection or the chart that was created based on the user's intent. Operations of the flowchart 300 are complete.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 4 depicts a computer system, according to some example embodiments. A computer system 400 includes a processor 401 (possibly including multiple processors, multiple cores, multiple nodes, and/or implementing multi-threading, etc.). The computer system includes volatile machine-readable medium 407. The volatile machine-readable medium 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, Hyper Transport®, InfiniBand®, NuBus, etc.), a network interface 405 (e.g., an ATM interface, an Ethernet interface, a Frame Relay interface, SONET interface, wireless interface, etc.), and a nonvolatile machine-readable medium 409 (e.g., optical storage, magnetic storage, etc).

The computer system 400 includes a data query module 425 and a chart module 426 that can perform the operations (as described herein). Any one of these functionalities may be partially (or entirely) implemented in hardware and/or on the processor 401. For example, the functionality may be implemented with an application specific integrated circuit, in logic implemented in the processor 401, in a co-processor on a peripheral device or card, etc.

Further, realizations may include fewer or additional components not illustrated in FIG. 4 (e.g., video cards, audio cards, additional network interfaces, peripheral devices, etc.). The processor 401, the nonvolatile machine-readable medium 409, and the network interface 405 are coupled to the bus 403. Although illustrated as being coupled to the bus 403, the memory 407 may be coupled to the processor 401.

While the embodiments are described with reference to various implementations and exploitations, it will be understood that these embodiments are illustrative and that the scope of the inventive subject matter is not limited to them. In general, techniques for chart generation based on user control inferences as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method comprising:
receiving, for each of a number of user interface controls, selections by a user of at least one of:
exactly one value,
a subset of values,
all values, and
no values,
wherein the selections by the user define non-chart-related settings;
inferring intent of the user of at least one attribute of a chart based on the selections by the user via the number of user interface controls; and
defining at least one characteristic of the chart for displaying the chart based on the intent.

2. The computer-implemented method of claim 1, wherein the inferring of the intent comprises:
in response to the selection of the exactly one value for a first user interface control of the number of user interface controls, inferring the intent of the user to view the chart for display such that the chart includes filtering of data by a first characteristic of the at least one characteristic defined by the exactly one value.

3. The computer-implemented method of claim 2, wherein the inferring of the intent comprises:
in response to the selection of the subset of values for a second user interface control of the number of user interface controls, inferring the intent of the user to view the chart for display such that the chart includes at least one of a sort and compare of data by a second characteristic of the at least one characteristic defined by the subset of values.

4. The computer-implemented method of claim 3, wherein the inferring of the intent comprises:
in response to the selection of all values for a third user interface control of the number of user interface controls, inferring the intent of the user to view the chart for display that does not consider a third characteristic of the at least one characteristic that has the all values.

5. The computer-implemented method of claim 4, wherein the inferring of the intent comprises:
in response to the selection of no values for a fourth user interface control of the number of user interface controls, inferring the intent of the user to view the chart for display that does not consider a fourth characteristic of the at least one characteristic that the no values.

6. The computer-implemented method of claim 2, wherein the inferring of the intent comprises:
in response to the selection of a first subset of values for a second user interface control of the number of user interface controls and the selection of a second subset of values for a third user interface control,
in response to a number of values of the first subset of values exceeding a first subset threshold and in response to a number of values of the second subset of values below a second subset threshold, inferring the intent of the user to view the chart for display such that the chart includes at least one of a sort and compare of data by a characteristic of the at least one characteristic defined by the third subset of values.

7. The computer-implemented method of claim 6, wherein the inferring of the intent comprises:
in response to the selection of a first subset of values for a second user interface control of the number of user interface controls and the selection of a second subset of values for a third user interface control,
in response to the number of values of the first subset of values exceeding the first subset threshold and in response to the number of values of the second subset of values exceeding the second subset threshold and in response to the number of values of the first subset of values being greater than the number of values of the second subset of values, inferring the intent of the user to view the chart for display such that the chart includes at least one of a sort and compare of data by a characteristic of the at least one characteristic defined by the third subset of values.

8. A computer program product for creating a chart, the computer program product comprising:
a computer readable storage medium having computer usable program code embodied therewith, the computer usable program code comprising a computer usable program code configured to:
receive, for each of a number of user interface controls, selections by a user of at least one of:
exactly one value,
a subset of values,
all values, and
no values,
wherein the selections by the user define non-chart-related settings;
infer intent of the user of at least one attribute of the chart based on the selections by the user via the number of user interface controls; and
define at least one characteristic of the chart for displaying the chart based on the intent.

9. The computer program product of claim 8, wherein the computer usable program code configured to infer of the intent comprises computer usable program code configured to:
in response to the selection of the exactly one value for a first user interface control of the number of user interface controls, infer the intent of the user to view the chart for display such that the chart includes filtering of data by a first characteristic of the at least one characteristic defined by the exactly one value.

10. The computer program product of claim 9, wherein the computer usable program code configured to infer of the intent comprises computer usable program code configured to:
in response to the selection of the subset of values for a second user interface control of the number of user interface controls, infer the intent of the user to view the chart for display such that the chart includes at least one of a sort and compare of data by a second characteristic of the at least one characteristic defined by the subset of values.

11. The computer program product of claim 10, wherein the computer usable program code configured to infer of the intent comprises computer usable program code configured to:
in response to the selection of all values for a third user interface control of the number of user interface controls, infer the intent of the user to view the chart for display that does not consider a third characteristic of the at least one characteristic that has the all values.

12. The computer program product of claim 11, wherein the computer usable program code configured to infer of the intent comprises computer usable program code configured to:
in response to the selection of no values for a fourth user interface control of the number of user interface controls, infer the intent of the user to view the chart for display that does not consider a fourth characteristic of the at least one characteristic that the no values.

13. The computer program product of claim 9, wherein the computer usable program code configured to infer of the intent comprises computer usable program code configured to:
in response to the selection of a first subset of values for a second user interface control of the number of user interface controls and the selection of a second subset of values for a third user interface control,
in response to a number of values of the first subset of values exceeding a first subset threshold and in response to a number of values of the second subset of values below a second subset threshold, infer the intent of the user to view the chart for display such that the chart includes at least one of a sort and compare of data by a characteristic of the at least one characteristic defined by the third subset of values.

14. The computer program product of claim 13, wherein the computer usable program code configured to infer of the intent comprises computer usable program code configured to:
in response to the selection of a first subset of values for a second user interface control of the number of user interface controls and the selection of a second subset of values for a third user interface control,
in response to the number of values of the first subset of values exceeding the first subset threshold and in response to the number of values of the second subset of values exceeding the second subset threshold and in response to the number of values of the first subset of values being greater than the number of values of the second subset of values, infer the intent of the user to view the chart for display such that the chart includes at least one of a sort and compare of data by a characteristic of the at least one characteristic defined by the third subset of values.

15. An apparatus comprising:
at least one processor; and
a data query module executable on the at least one processor, the data query module configured to,
receive, for each of a number of user interface controls, selections by a
user of at least one of:
exactly one value,
a subset of values,
all values, and no values,
wherein the selections by the user define non-chart-related settings;
a chart module executable on the at least one processor, the chart module configured to
infer intent of the user of at least one attribute of the chart based on the selections by the user via the number of user interface controls; and
define at least one characteristic of the chart for displaying the chart based on the intent.

16. The apparatus of claim 15, wherein as part of the infer, the chart module is configured to:
in response to the selection of the exactly one value for a first user interface control of the number of user interface controls, infer the intent of the user to view the chart for display such that the chart includes filtering of data by a first characteristic of the at least one characteristic defined by the exactly one value.

17. The apparatus of claim 16, wherein as part of the infer, the chart module is configured to:
in response to the selection of the subset of values for a second user interface control of the number of user interface controls, infer the intent of the user to view the chart for display such that the chart includes at least one of a sort and compare of data by a second characteristic of the at least one characteristic defined by the subset of values.

18. The apparatus of claim 17, wherein as part of the infer, the chart module is configured to:
in response to the selection of all values for a third user interface control of the number of user interface controls, infer the intent of the user to view the chart for display that does not consider a third characteristic of the at least one characteristic that has the all values.

19. The apparatus of claim 16, wherein as part of the infer, the chart module is configured to:
in response to the selection of a first subset of values for a second user interface control of the number of user interface controls and the selection of a second subset of values for a third user interface control,
in response to a number of values of the first subset of values exceeding a first subset threshold and in response to a number of values of the second subset of values below a second subset threshold, infer the intent of the user to view the chart for display such that the chart includes at least one of a sort and compare of data by a characteristic of the at least one characteristic defined by the third subset of values.

20. The apparatus of claim 19, wherein as part of the infer, the chart module is configured to:
in response to the selection of a first subset of values for a second user interface control of the number of user interface controls and the selection of a second subset of values for a third user interface control,
in response to the number of values of the first subset of values exceeding the first subset threshold and in response to the number of values of the second subset of values exceeding the second subset threshold and in response to the number of values of the first subset of values being greater than the number of values of the second subset of values, infer the intent of the user to view the chart for display such that the chart includes at least one of a sort and compare of data by a characteristic of the at least one characteristic defined by the third subset of values.
